(19) United States
(12) Patent Application Publication
(10) Pub. No.: US 2025/0305618 A1
(43) Pub. Date: Oct. 2, 2025

(54) INSPECTION TOOL AND METHODS FOR LOCATING AND REMOVING OBSTRUCTIONS FROM A CHANNEL

(71) Applicant: GM GLOBAL TECHNOLOGY OPERATIONS LLC., Detroit, MI (US)

(72) Inventors: Derek F. Lahr, Ann Arbor, MI (US); Anthony M. Coppola, Rochester Hills, MI (US); Alireza Fatemi, Canton, MI (US); William T. Kucinski, Windsor, Ontario (CA); Charles W. McClure, White Lake Twp., MI (US); Mohammad Hamza Kirmani, Troy, MI (US)

(73) Assignee: GM GLOBAL TECHNOLOGY OPERATIONS LLC, Detroit, MI (US)

(21) Appl. No.: 18/624,501

(22) Filed: Apr. 2, 2024

(51) Int. Cl. F16L 55/30; F16L 101/12; F16L 101/30

(52) U.S. Cl. CPC F16L 55/30; F16L 2101/12; F16L 2101/30

(57) ABSTRACT

This disclosure describes inspection tools and methods to inspect and maintain the interior of vent gas manifold channels. A magnetically-coupled probe, (e.g., a ball, cylinder, rectangular cube, or disc), is inserted inside the vent gas manifold channel. A magnetically-coupled head then magnetically drags the magnetically-coupled probe through the channels of the vent gas manifold. The inspection tool uses a sensor to monitor the position of the magnetically-coupled probe inside of the channel. If an obstruction is encountered, the sensor monitors local changes in one of more physical or electrical properties of the inspection tool and alerts an operator. The magnetically-coupled probe may be a steel bucket with sharp leading edges that detaches and scoops up the obstruction. A programmed robot manipulator arm or human operator may move the head across the surface of the vent gas manifold parallel to the channel.

### INTRODUCTION

This disclosure relates to inspection tools and methods for inspecting channels for obstructions located inside of the channel and for removing them after being identified. In particular, the disclosure relates to inspection of vent gas manifold channels in an electric vehicle battery pack.

Electric vehicle battery packs are made up of multiple battery cells stacked in an array and enclosed in a structure that securely holds the batteries in place. Battery packs may have a vent gas manifold system (e.g., a series of parallel channels). Some of these battery packs may also be potted with a polymer (e.g., silicone or polyurethane).

### SUMMARY

This disclosure describes inspection tools and methods to inspect and maintain the interior of vent gas manifold channels. A magnetically-coupled probe, (e.g., a ferrous steel or magnetic ball, cylinder, rectangular cube, or disc), is inserted inside the vent gas manifold channel. Then, an external, magnetically-coupled head is used to magnetically drag the magnetically-coupled probe through the channels of the vent gas manifold. The inspection tool uses a sensor to monitor the position of the magnetically-coupled probe inside of the channel. If an obstruction is encountered, the sensor monitors local changes in one of more physical, electrical, or magnetic properties of the inspection tool and alerts an operator of the obstruction. The magnetically-coupled probe may comprise a steel bucket with upper and lower sharp leading edges that cuts, detaches, and scoops up the obstruction, which may be removed by removing the steel bucket from the channel. A human operator or a programmed robot manipulator arm may move the magnetically-coupled head across the surface of the vent gas manifold in a direction parallel to the channel.

In a first example, an inspection toolset may include: a magnetically-coupled probe sized to fit within, and slide along, the channel; an inspection tool comprising a magnetically-coupled head disposed outside of the channel; and a sensor, attached to, or disposed within, the magnetically-coupled head; wherein the sensor is configured to detect when the magnetically-coupled probe has encountered an obstruction located inside of the channel; and wherein the magnetically-coupled head and the magnetically-coupled probe are magnetically-coupled together to make a magnetically-coupled probe/head pair that have a magnetic strength sufficiently strong to drag the probe inside the channel when the head is moved outside of the channel.

In another example, the inspection toolset may further include a shaft attached to the magnetically-coupled head and the sensor, disposed in-between the magnetically-coupled head and the sensor; and wherein the sensor is configured to sense an increase in a lateral force, a torque, and/or a lateral deflection of the shaft when the magnetically-coupled probe encounters the obstruction located inside of the channel.

In another example, a sensor may sense: (a) a change in an electrical capacitance of the magnetically-coupled probe, and/or (b) a change in an electrical inductance of an electromagnet disposed inside of the magnetically-coupled head; when the magnetically-coupled probe encounters the obstruction.

In another example, the inspection tool may be attached to, and manipulated by, a robotic manipulator arm; or manipulated by a human operator.

In another example, the vent gas manifold channel may be disposed within a battery vent gas manifold system of an electric vehicle.

In another example, a method of inspecting a channel with a inspection tool, may include: (a) providing an inspection tool comprising: a magnetically-coupled probe sized to fit within, and slide along, the channel; an inspection tool comprising a head disposed outside of the channel; and a sensor, attached to, or disposed within, the head; wherein the sensor is configured to detect when the magnetically-coupled probe has encountered an obstruction located inside of the channel; and wherein the head and the magnetically-coupled probe are magnetically-coupled together to make a magnetically-coupled probe/head pair that are coupled together with a magnetic strength sufficiently strong to drag the probe inside the channel when the head is moved outside of the channel; then (b) inserting a magnetically-coupled probe into the channel; then (c) placing the magnetically-coupled head in close proximity to the channel and sliding the magnet or the electromagnet along the channel, thereby applying a moving external magnetic field that drags the magnetically-coupled probe along the channel; then (d) detecting, with the sensor, one or more changes in a physical, electrical, and/or a magnetic property of the inspection tool when the magnetically-coupled probe encounters the obstruction; and then (e) alerting a human operator that the obstruction has been detected.

In another example, the method may further includes applying a physical map, or projecting a video display, to an exterior surface of the battery pack, showing locations of internal channels disposed within a battery pack, and using the map or display to guide a human operator to move the magnetically-coupled probe along the channel.

In another example, the inspection tool may further include a shaft attached to the magnetically-coupled head; and the method further comprises measuring a lateral force, a torque, and/or a lateral deflection of the shaft that is generated when the magnetically-coupled probe encounters the obstruction located inside of the channel.

In another example, the method may further include measuring with the sensor: (a) a change in an electrical capacitance of the magnetically-coupled probe/head pair; and/or (b) a change in an electrical inductance of an electromagnet disposed within the magnetically-coupled head; when the obstruction is encountered.

In another example, the inspection tool may be attached to a robot manipulator arm; and the method further comprises moving the inspection tool and the magnetically-coupled probe along the channel with the robot manipulator arm.

In another example, the method further may include: (f) removing the obstruction from the channel after the magnetically-coupled probe has located the obstruction; and (g) removing the magnetically-coupled probe from the channel after inspection has been completed.

In another example, the method may further include holding the magnetically-coupled probe at one end of the channel after inspection has been completed.

In another example, the magnetically-coupled probe may comprise ferrous steel or a magnet; and wherein the magnetically-coupled head may comprise a ferrous steel or a magnet.

In another example, removing the obstruction in step (f) may include: (1) magnetically moving, with a magnetically-coupled head, a magnetically-coupled bucket disposed inside of the channel, wherein the magnetically-coupled bucket comprises upper and lower sharp leading edges; (2) cutting away and detaching the obstruction from a wall of the channel by pushing the magnetically-coupled bucket forward into and past the obstruction, thereby cutting and creating a detached obstruction; (3) holding the detached obstruction in the magnetically-coupled bucket; and then (4) removing the magnetically-coupled bucket, with the detached obstruction held inside, from the channel.

In another example, the method may further include, after step (2), vacuuming up the detached obstruction with a vacuum tube attached to a rear end of the magnetically-coupled bucket; thereby removing the detached obstruction from the channel.

In another example, the method may further include using a plurality of fixed or rotating blades; or a pair of snipper jaws, or a plurality of rotating gears that cut or grind the obstruction into a plurality of small, individual pieces.

In another example, the channel may be disposed within a battery vent gas manifold system of an electric vehicle.

In another example, the method further may include holding the magnetically-coupled probe at an end of the channel after completing inspection comprises rotating a one-way turn-style post with a pair of arms that captures and traps the magnetically-coupled probe at the end of the channel.

In another example, the method may further include holding the magnetically-coupled probe at an end of the channel after completing inspection comprises using a permanent magnet disposed at the end of the channel to capture and hold the magnetically-coupled probe at the end of the channel.

In another example, a method of inspecting a channel with an inspection tool, may include: (a) providing an inspection toolset comprising: a magnetically-coupled probe sized to fit within, and slide along, the channel; an inspection tool comprising a magnetically-coupled head disposed outside of the channel; and a sensor, attached to, or disposed within, the magnetically-coupled head; wherein the sensor is configured to detect when the magnetically-coupled probe has encountered an obstruction located inside of the channel; and wherein the magnetically-coupled head and the magnetically-coupled probe are magnetically-coupled together to make a magnetically-coupled probe/head pair that have a magnetic strength sufficiently strong to drag the magnetically-coupled probe inside the channel when the magnetically-coupled head is moved outside of the channel, then; (b) inserting a magnetically-coupled probe into the channel; then (c) placing the magnetically-coupled head in close proximity to the channel and sliding the magnetically-coupled head along the channel, thereby dragging the magnetically-coupled probe along the channel, then; (d) detecting, with the sensor, one or more changes in a physical, electrical, and/or a magnetic property of the inspection tool when the magnetically-coupled probe encounters the obstruction; and then (e) alerting a human operator that the obstruction has been located; wherein the inspection tool further comprises a shaft attached to the magnet or the electromagnet; wherein the method further comprises measuring a lateral force, a torque, and/or a lateral deflection of the shaft that is generated when the magnetically-coupled probe encounters the obstruction; wherein the inspection tool is attached to a robot manipulator arm; and wherein the method further comprises moving the inspection tool and the magnetically-coupled probe along a length of the channel with the robot manipulator arm.

### BRIEF DESCRIPTION OF THE DRAWINGS

FIG. 1 shows a schematic elevation view of an example of a battery pack with three, parallel vent gas manifold channels, according to the present disclosure.

FIG. 2A shows a schematic elevation view of an example of an inspection tool and probe inspecting a vent gas manifold channel, according to the present disclosure.

FIG. 2B shows a schematic elevation view of an example of an inspection tool and probe inspecting a vent gas manifold channel, and encountering an obstruction, according to the present disclosure.

FIG. 3A shows a schematic plan view of an example of a pair of vent gas manifold channels with a magnetically-coupled probe and a borescope hole penetrating a side wall at an end of a channel, according to the present disclosure.

FIG. 3B shows a schematic plan view of an example of a vent gas manifold channel with a removed magnetically-coupled probe and a plugged borescope hole, according to the present disclosure.

FIG. 4 shows a schematic plan view of an example of a vent gas manifold with multiple, interconnected parallel channels with a magnetically-coupled probe, according to the present disclosure.

FIG. 5A shows a schematic plan view of an example of a vent gas manifold channel with a magnetically-coupled probe and a turn-style mechanism that acts as a trap, according to the present disclosure.

FIG. 5B shows a schematic plan view of an example of a vent gas manifold channel with a magnetically-coupled probe and a turn-style mechanism rotated in a captured position, according to the present disclosure.

FIG. 6A shows a schematic plan view of an example of a vent gas manifold channel with a magnetically-coupled probe and a magnet at an end of the channel, according to the present disclosure.

FIG. 6B shows a schematic plan view of an example of a vent gas manifold channel with a magnetically-coupled probe attached to a magnet at an end of the channel, according to the present disclosure.

FIG. 7A shows a schematic elevation view of an example of a cylindrical magnet and a spherical probe, according to the present disclosure.

FIG. 7B shows a schematic elevation view of an example of a cylindrical magnet and a cylindrical probe, according to the present disclosure.

FIG. 7C shows a schematic elevation view of an example of a horseshoe-shaped magnet and a cylindrical probe, according to the present disclosure.

FIG. 7D shows a schematic elevation view of an example of a cylindrical magnet and a disc-shaped probe, according to the present disclosure.

FIG. 7E shows a schematic perspective view of an example of a cylindrical magnet and a bucket-shaped probe, according to the present disclosure.

FIG. 8A shows a schematic elevation cross-section view of an example of three battery cells and a vent gas manifold channel with an obstruction inside of the channel, according to the present disclosure.

FIG. 8B shows a schematic elevation cross-section view of an example of three battery cells and a vent gas manifold channel with an obstruction inside of the channel, according to the present disclosure.

FIG. 9 shows a schematic elevation cross-section view of an example of three battery cells and a vent gas manifold channel with an obstruction inside of the channel, according to the present disclosure.

FIG. 10 shows a schematic elevation cross-section view of an example of three battery cells and a vent gas manifold channel with an obstruction inside of the channel, according to the present disclosure.

FIG. 11 shows a schematic elevation cross-section view of an example of three battery cells and a vent gas manifold channel with an obstruction inside of the channel, according to the present disclosure.

FIG. 12A shows a schematic plan view of an example of a magnetically-coupled disc with four spherical rollers disposed underneath the disc, according to the present disclosure.

FIG. 12B shows an elevation cross-section view of an example of a magnetically-coupled disc with four spherical rollers disposed underneath the disc, according to the present disclosure.

FIG. 13 shows an example of a process flow chart showing a method of inspecting a vent gas manifold channel.

FIG. 14 shows a schematic elevation cross-section view of an example of three battery cells and a vent gas manifold channel with an obstruction and a laser disposed inside of the channel, according to the present disclosure.

FIG. 15 shows a schematic elevation cross-section view of an example of three battery cells and a vent gas manifold channel with an obstruction and a borescope with snipper jaws disposed inside of the channel, according to the present disclosure.

### DETAILED DESCRIPTION

This disclosure describes inspection tools and methods to inspect and maintain the interior of vent gas manifold channels. A ferrous or magnetic probe, (e.g., a steel ball, cylinder, rectangular cube, or disc), is inserted inside the vent gas manifold channel. Then, an external magnetic field from a magnetically-coupled head is then used to magnetically drag the probe through the channels of the vent gas manifold. The inspection tool uses a sensor to monitor the position of the magnetically-coupled probe inside of the channel. If an obstruction is encountered, the sensor monitors local changes in one of more physical, electrical, or magnetic properties of the inspection tool and alerts an operator of the obstruction. The magnetically-coupled probe may be a steel bucket with upper and lower sharp leading edges that cuts, detaches, and scoops up the obstruction, which may be removed by removing the magnetically-coupled bucket from the channel. A human operator or programmed robot manipulator arm may move the magnetically-coupled head across the surface of the vent gas manifold in a direction parallel to the channel.

The term “magnet” as used herein may include permanent magnets, electromagnets, or combinations thereof.

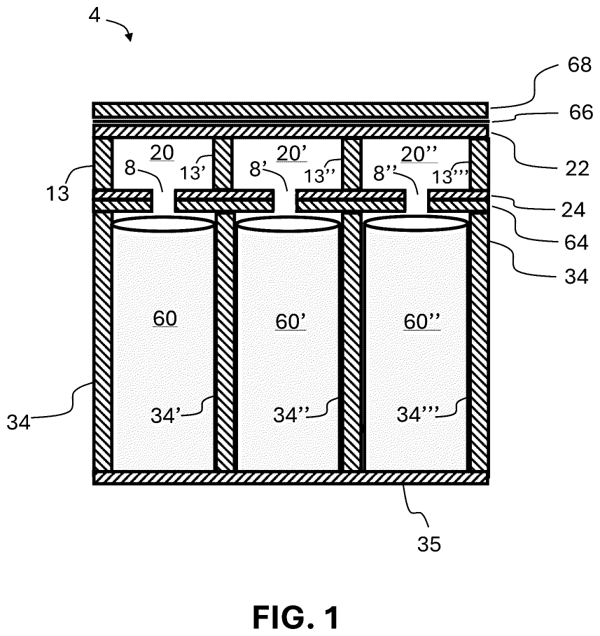

FIG. 1 shows a schematic elevation view of example of a battery pack 4 with three, parallel vent gas manifold channels 20, 20′, and 20″, according to the present disclosure. Passageways 8, 8′, and 8″ fluidically connect vent gases from battery cells 60, 60′, and 60″ to vent gas manifold channels 20, 20′, and 20″, respectively. Potting layers (e.g., silicone or polyurethane) 34, 34′, 34″, 34′″, and 35 surround and support battery cells 20, 20′, and 20″, respectively. Horizontal cell holder tray 64 is disposed above and across battery cells 20, 20′, and 20″. Lower wall 24 extends horizontally across the bottom of vent gas manifold channels 20, 20′, and 20″. TP tray 22 is disposed horizontally across the upper part of vent gas manifold channels 20, 20′, and 20″. Upper shear plate 68 is disposed horizontally above TP tray 22, with potting layer 66 disposed in-between TP tray 22 and horizontal upper shear plate 68.

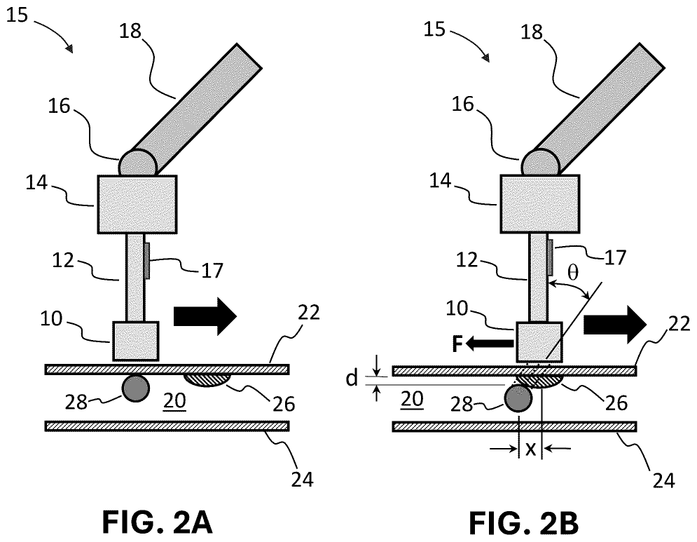

FIG. 2A shows a schematic elevation view of example of an inspection tool 15 and magnetically-coupled probe 28 inspecting a vent gas manifold channel 20, according to the present disclosure. Inspection tool 15 comprises magnetically-coupled head 10 that may be attached to shaft 12. Shaft 12 is attached to sensor 14. Sensor 14 may optionally be attached to a robotic manipulator arm 18 via rotatable joint 16. Alternatively, sensor 14 may be hand-held and guided by a human operator (not shown) who may follow a template attached to the battery pack that visually shows the location of parallel vent gas manifold channels disposed inside of the structure that holds the battery pack (see FIG. 1). Inspection tool 15 may comprise electronics and visual and/or audio alerting means (not shown) for alerting a human operator, or for wirelessly alerting a monitoring computer, that an obstruction has been detected. Sensor 14 may be disposed inside of magnetically-coupled head 10.

Referring still to FIG. 1, magnetically-coupled probe 28 is inserted inside of vent gas manifold channel 20, where it is pulled up by magnetic attraction against upper channel wall 22. Channel wall 22 may be made of a non-magnetic material (e.g., a polymer or aluminum). Magnetically-coupled probe 28 may be made of a ferrous material, steel, low-carbon steel, or magnet. Magnetically-coupled head 10 may be a magnet, in which case magnetically-coupled probe 28 may be a ferrous steel part or a magnet. Alternatively, magnetically-coupled head 10 may be a ferrous steel part, in which case magnetically-coupled probe 28 is a magnet. In all of these options, magnetically-coupled head 10 and magnetically-coupled probe 28 are magnetically-coupled together to make a magnetically-coupled probe/head pair. Moving inspection tool 15 sideways causes magnetically-coupled probe 28 to be dragged sideways inside of channel 20. Obstruction 26 may be a blog of potting compound that has intruded into channel 20 at a small opening or hole (not shown) in upper channel wall 22. In FIG. 2A, magnetically-coupled probe 28 has not yet encountered obstruction 26. Magnetically-coupled probe 28 may have the shape of a sphere, cylinder, rectangular cube, disc, or a U-shaped bucket/scoop.

FIG. 2B shows a schematic elevation view of an example of an inspection tool 15 and magnetically-coupled probe 28 inspecting a vent gas manifold channel 20, and encountering an obstruction 26, according to the present disclosure. In this illustration, magnetically-coupled probe 28 has contacted obstruction 26, which displaces magnetically-coupled probe 28 downwards away from the ceiling of channel 20 by a distance=d. This causes magnetically-coupled probe 28 to be offset from magnetically-coupled head 10 by a horizontal distance=X, in turn, increases the angle, q, of the magnetic field lines (shown as dashed lines). The increase in the angle, q, of the magnetic field lines and/or the displacements (d, X) of magnetically-coupled probe 28 from it's normal (un-deflected) position may be sensed by sensor 14 in different physical or electrical ways. In one example, a strain gauge 17 may be mounted vertically on a side of shaft 12, which responds to bending of shaft 12 when a sideways magnetic force, F, is applied due to encountering obstruction 26. The force, F, or bending moment (Torque, T) may be calculated by sensor 14 and strain gauge 17. A step increase in this force, F, indicates that magnetically-coupled probe 28 has contacted obstruction 26.

In another example, magnetically-coupled head 10 may comprise a capacitance sensor that monitors the capacitance of the separation between magnetically-coupled probe 28 and magnetically-coupled head 10. Step increases in distances d and X, that increase in a step-wise manner when magnetically-coupled probe 28 contacts obstruction 26, increase the capacitance of inspection tool 15. In another example, the electrical inductance of an electromagnetically-coupled head 10 may be monitored for sudden changes in the inductance when obstruction 26 is encountered. In another example, a magnetic field sensor (e.g., a Hall sensor) may be used to monitor changes in the magnetic strength and direction (angle, q), when obstruction 26 is encountered. In another example, magnetically-coupled head 10 may comprise an ultrasound sensor that monitors the separation distances (d, x) between magnetically-coupled probe 28 and magnetically-coupled head 10 when obstruction 26 is encountered. In a final example, magnetically-coupled head 10 may comprise an eddy current sensor that monitors changes in eddy currents due to changes in the separation distances (d, x) between magnetically-coupled probe 28 and magnetically-coupled head 10 when obstruction 26 is encountered.

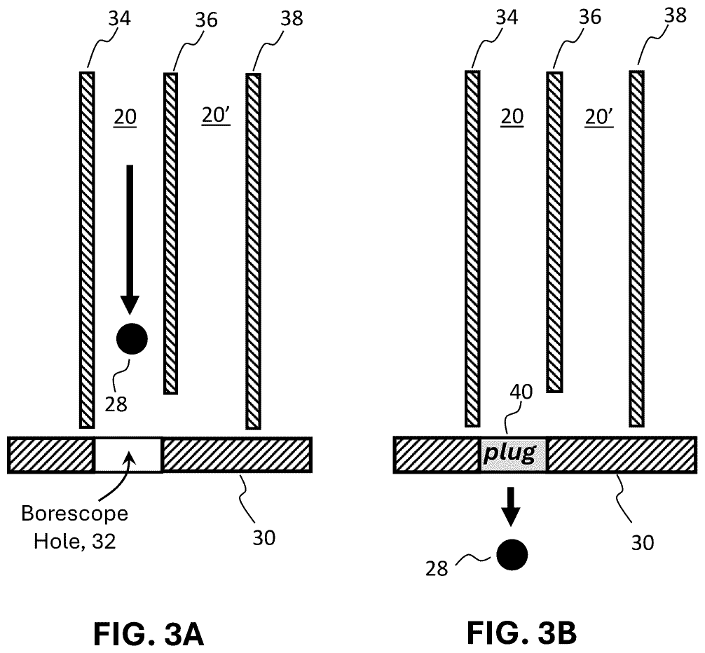

FIG. 3A shows a schematic plan view of an example of a pair of vent gas manifold channels 20 and 20′ with a magnetically-coupled probe 28 and a borescope hole 32 penetrating a side wall 30 wall at an end of channel 20, according to the present disclosure. The purpose of borescope hole (which may be any type of hole) is to allow magnetically-coupled probe 28 to be removed from the vent gas manifold channel 20 after inspection has been completed.

FIG. 3B shows a schematic plan view of an example of a vent gas manifold channel 20 with a removed magnetically-coupled probe 28 and a borescope hole 32 sealed with a plug 40, according to the present disclosure. Hole 32 is plugged with plug 40 after magnetically-coupled probe 28 has been removed from channel 20.

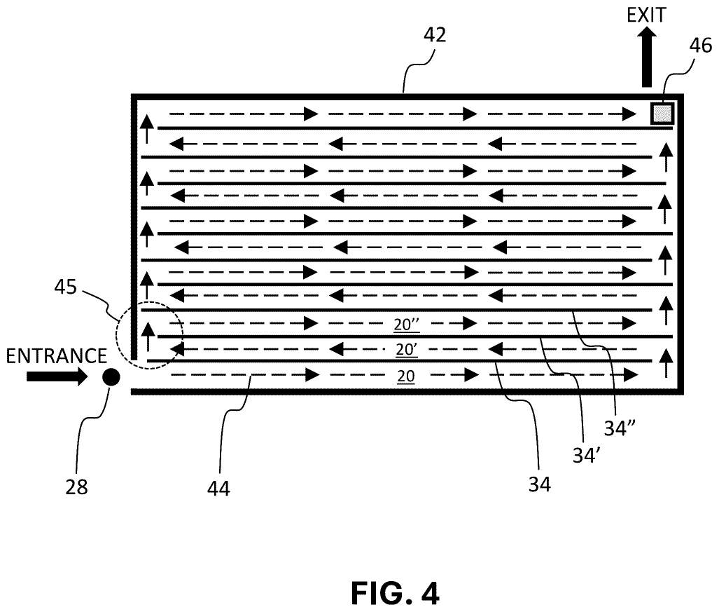

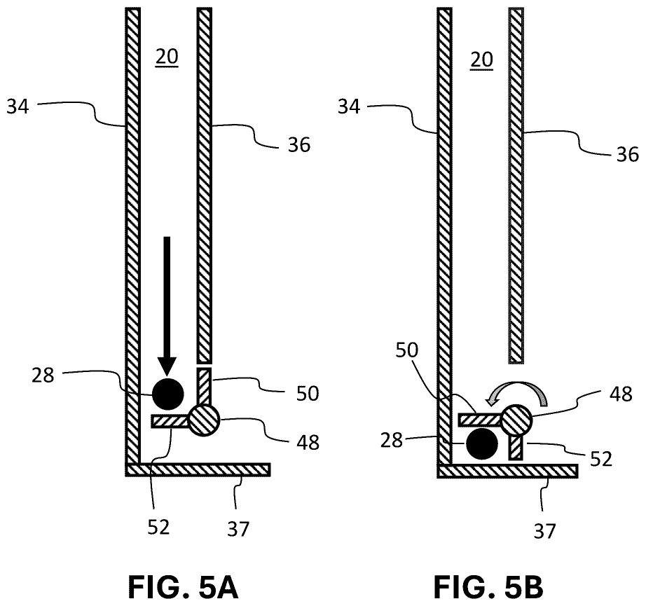

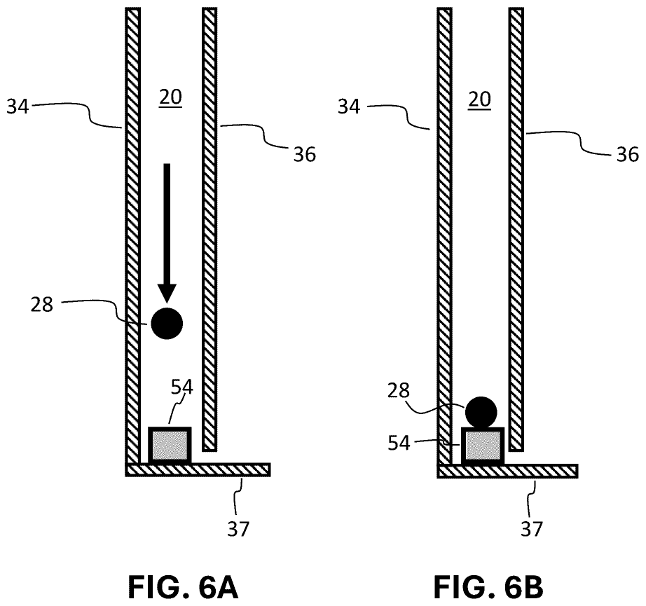

FIG. 4 shows a schematic plan view of an example of a vent gas manifold 42 with multiple, interconnected parallel channels 20, 20′, 20″, etc. and a magnetically-coupled probe 28, according to the present disclosure. Magnetically-coupled probe 28 enters at a corner of vent gas manifold 42 and is remotely dragged (magnetically) by moving inspection tool 15 (not shown) along the length of interconnected vent gas manifold channels 20, 20′, 20″, etc., thereby searching/probing for one or more obstructions (not shown) that might be located inside of channels 20, 20′, 20″, etc. Multiple vent gas manifold channels 20, 20′, 20″, etc. form a serpentine pattern of interconnected pathways 44, separated by multiple, parallel internal walls 34, 34′, etc. When magnetically-coupled probe 28 reaches the end of the interconnected channels 20, 20′, 20″, etc. it may be either (1) removed through a temporary hole or opening in a sidewall of the vent gas manifold 42 (the hole is later plugged), or (2) trapped/captured/held/retained inside of manifold 42 by trap 46. Trap 46 may comprise, for example, a turn-style mechanism (see FIGS. 5A and 5B). Alternatively, trap 46 may comprise a permanent magnet (see FIGS. 6A and 6B). Alternatively, trap 46 may comprise a sticky, adhesive pad (not shown).

FIG. 5A shows a schematic plan view of an example of a vent gas manifold channel 20 with a magnetically-coupled probe 28 and a turn-style mechanism 48 that acts as a trap 46, according to the present disclosure. Turn-style mechanism 48 comprises first and second short arms (i.e., blades) 50 and 52, disposed at a right angle to each other, which are attached to a vertical post 48 that is rotatable. Magnetically-coupled probe 28 is magnetically-coupled to rest against second arm 52 in FIG. 5A.

FIG. 5B shows a schematic plan view of an example of a vent gas manifold channel 20 with a magnetically-coupled probe 28 and a turn-style mechanism 48 rotated in a captured position, according to the present disclosure. Here, rotatable post 48 has rotated counter-clockwise 90 degrees, which causes first arm 50 to trap and hold magnetically-coupled probe 28 in-between first arm 50 and second arm 52, and against partition 34 and lower wall segment 37 (thereby forming a box-shaped trap).

FIG. 6A shows a schematic plan view of an example of a vent gas manifold channel 201 with a magnetically-coupled probe 28 and a magnet 54 at an end of the channel, according to the present disclosure. Magnetically-coupled probe 28 is being dragged towards magnet 54 at the end of the channel 20.

FIG. 6B shows a schematic plan view of an example of a vent gas manifold channel 20 with a magnetically-coupled probe 28 attached to a magnet 54 at an end of channel 20, according to the present disclosure. Magnet 54 traps magnetically-coupled probe 28 at the end of channel 20.

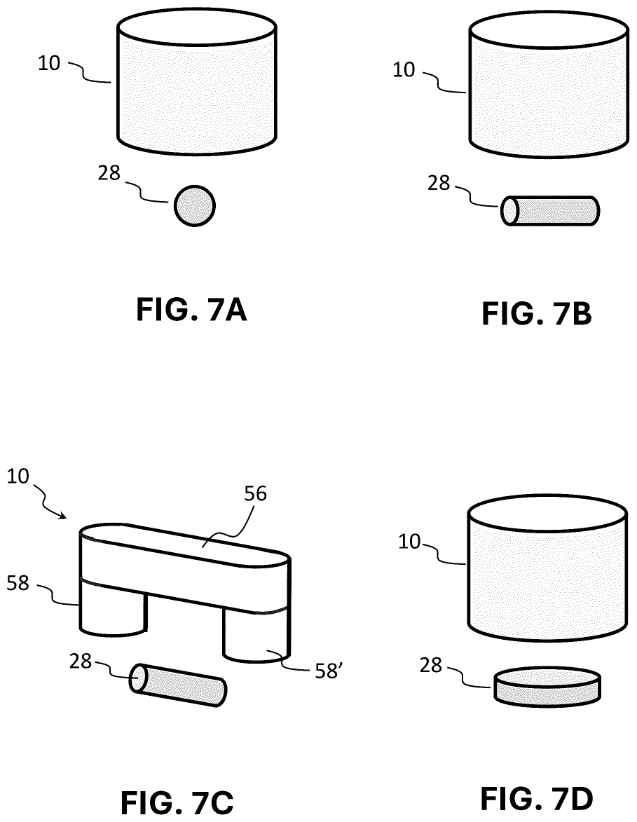

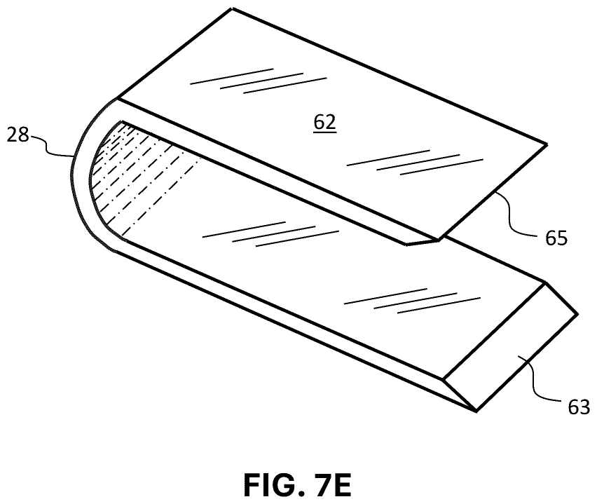

FIG. 7A shows a schematic elevation view of an example of a cylindrical magnetically-coupled head 10 and a spherical magnetically-coupled probe 28, according to the present disclosure. Magnetically-coupled head 10 may be made of a rare earth magnetic material, Ferrite, or other magnetic material (e.g. NdFe₃₅). Magnetically-coupled probe 28 may be made of steel, low carbon steel, or a magnet. In this configuration, the magnetic force may equal about 7 N.

FIG. 7B shows a schematic elevation view of an example of a cylindrical magnetically-coupled head 10 and a cylindrical magnetically-coupled probe 28, according to the present disclosure. Magnetically-coupled head 10 may be made of a rare earth magnetic material, Ferrite, or other magnetic material (e.g. NdFe₃₅). Magnetically-coupled probe 28 may be made of steel, low carbon steel, or a magnet. In this configuration, the magnetic force may equal about 21 N.

FIG. 7C shows a schematic elevation view of an example of a horseshoe-shaped magnetically-coupled head 10 and a cylindrical magnetically-coupled probe 28, according to the present disclosure. Magnetically-coupled head 10 may be made of a rare earth magnetic material, Ferrite, or other magnetic material (e.g. NdFe₃₅). Magnetically-coupled probe 28 may be made of steel, low carbon steel, steel 1010, or a magnet. The diameter of cylindrical magnetically-coupled probe 28 may be about 12 mm, with a length of about 20 mm. In this configuration, the magnetic force may equal about 45 N.

FIG. 7D shows a schematic elevation view of an example of a cylindrical magnetically-coupled head 10 and a disc-shaped magnetically-coupled probe 28, according to the present disclosure. Magnetically-coupled head 10 may be made of a rare earth magnetic material, Ferrite, or other magnetic material (e.g. NdFe₃₅). Magnetically-coupled probe 28 may be made of steel, low carbon steel, steel 1010, or a magnet. The diameter of disc-shaped magnetically-coupled probe 28 may be about 20 mm, with a thickness of about 12 mm. In this configuration, the magnetic force may equal about 40 N.

FIG. 7E shows a schematic perspective view of an example of a U-shaped shaped magnetically-coupled probe 28 with upper and lower sharp leading edges 66 and 63, respectively, according to the present disclosure. Magnetically-coupled probe 28 may also be called a “bucket probe 62”. The U-shaped magnetically-coupled probe 28 may be sized to fit within a vent gas manifold channel, being sufficiently small that it may easily traverse and move through a 180-degree turn-around section of the ends of a pair of parallel, adjacent vent gas manifold channels (see FIG. 4). U-shaped bucket probe 62 may function as a magnetically-coupled probe 28, or it may function simply as a scoop to cut and hold a blob of intruded potting compound (e.g., obstruction 26), in which case a separate magnetically-coupled probe 28 would be used during the inspection steps.

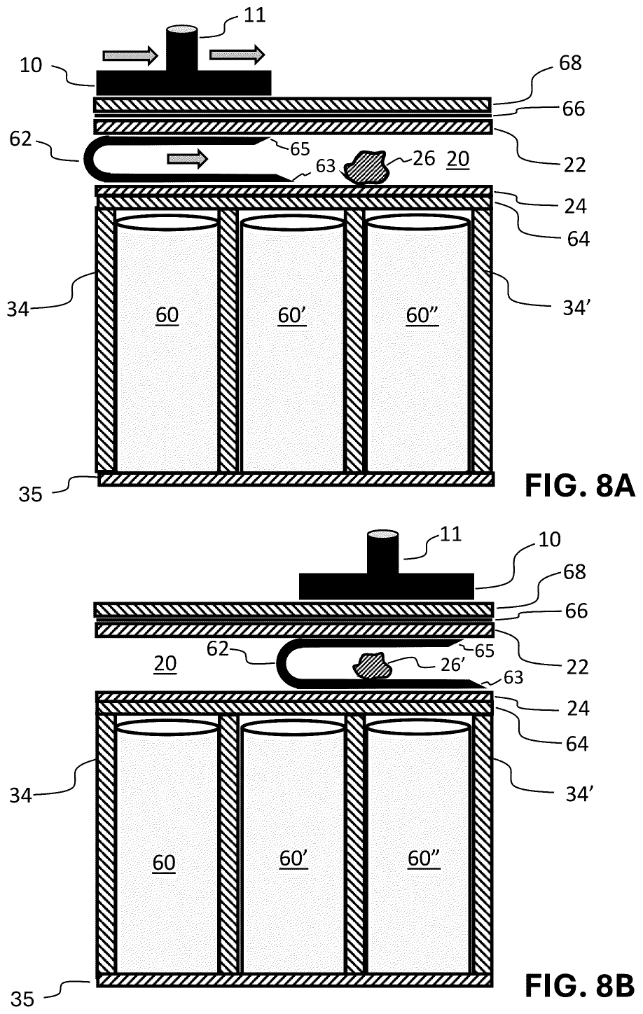

FIG. 8A shows a schematic elevation cross-section view of an example of three battery cells 60, 60′, 60″ and a vent gas manifold channel 20 with an obstruction 26 inside of the channel, according to the present disclosure. Obstruction 26 may be a blob of potting compound that has intruded inside of channel 20. Steel bucket 62 is a U-shaped “scoop” that may be magnetically-dragged inside of channel 20 by moving external magnetically-coupled head 10 horizontally across upper shear plate 68. External magnetically-coupled head 10 has a vertical shaft/extension 11 that may act as a handle for a human operator or robotic manipulator arm (not shown) to hold and move. Steel bucket 62 may comprise a pair of lower and upper sharpened tips/blades 63 and 65, respectively, that may cut off the protruding obstruction 26 from, for example, lower wall 24). Magnetically-coupled head 10 drags steel bucket 62 horizontally through channel 20 until obstruction 26 is encountered, at which point steel bucket 62 then slices and cuts off the protruding obstruction 26 (for example, from lower wall 24). The cut-off obstruction 26′ is then held inside of steel bucket 62 (See FIG. 8B), where steel bucket 62 may be removed later from channel 20. Lower sharpened tip/blade 63 extends horizontally further to the right than upper sharpened tip/blade 65 of steel bucket 62, so that when obstruction 26 is intruded from upper TP tray 22, the cut-off obstruction 26′ falls down onto the longer lower sharpened tip/blade 63 and is captured by steel bucket 62. Note that the outer dimensions and shape of steel bucket 62 should be sufficiently narrow so that magnetically-coupled steel bucket 62 may successfully navigate the 180-degree turn at turn-around point 45 of parallel channels 20′, and 20″ in vent gas manifold 42 without getting stuck at the turn-around point 45 (see FIG. 4).

FIG. 8B shows a schematic elevation cross-section view of an example of three battery cells 60, 60′, 60″ and a vent gas manifold channel 20 with an obstruction 26 inside of channel 20, according to the present disclosure. In this view, steel bucket 62 holds cut-off obstruction 26′. Steel bucket 62, with cut-off obstruction 26′ held inside, may later be removed from channel 20, thereby clearing channel 20 of obstructions. Note: multiple obstructions (not shown) may be individually cut-off and collected by steel bucket 62, prior to removing steel bucket 62 from channel 20.

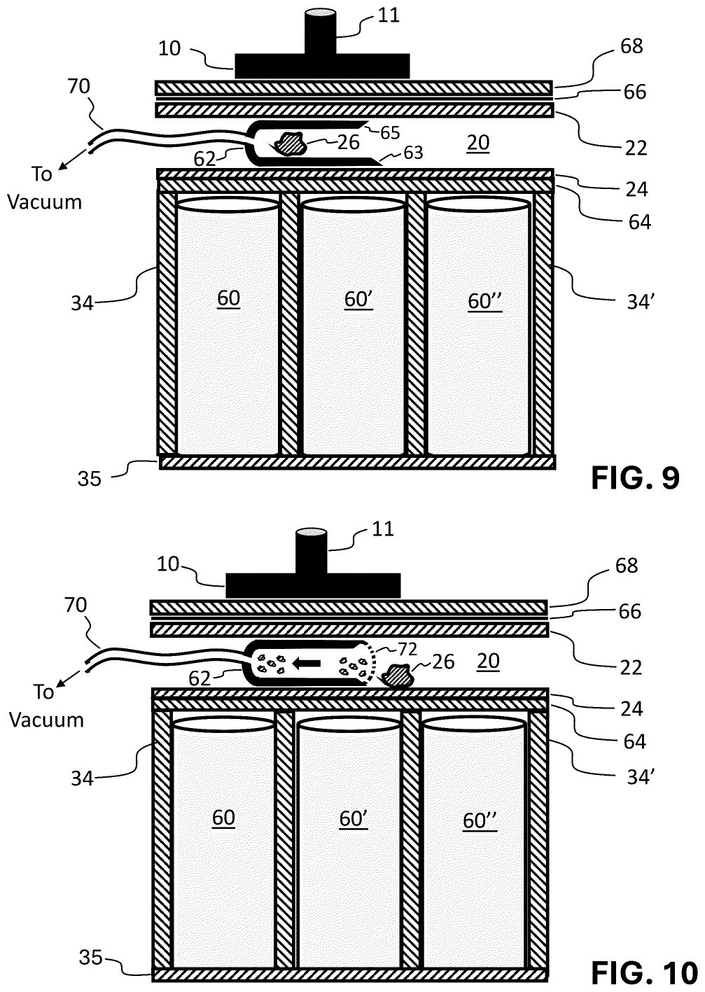

FIG. 9 shows a schematic elevation cross-section view of an example of three battery cells 60, 60′, 60″ and a vent gas manifold channel 20 with an obstruction 26 inside of the channel 20, according to the present disclosure. This figure is identical to FIG. 8A, with the exception being that a flexible vacuum tube 70 has been added to a rear end of steel bucket 62. This provides the capability to suck out and permanently remove the cut-off obstruction 26 from the inside of steel bucket 62, especially if obstruction 26 is liquid or semi-liquid. Flexible vacuum tube 70 may have a diameter sufficiently large to pass a solidified, cut-off obstruction 26′ through tube 70.

FIG. 10 shows a schematic elevation cross-section view of an example of three battery cells 60, 60′, 60″ and a vent gas manifold channel 20 with an obstruction 26 inside of the channel 20, according to the present disclosure. This figure is identical to FIG. 9, with the exception being the addition of a sharp mesh (array) 72 of multiple sharp blades to the front/leading end of steel bucket 62. Sharp mesh 72 chops (minces) obstruction 26 into multiple, smaller pieces/fragments, which are easier to vacuum out through flexible vacuum tube 70.

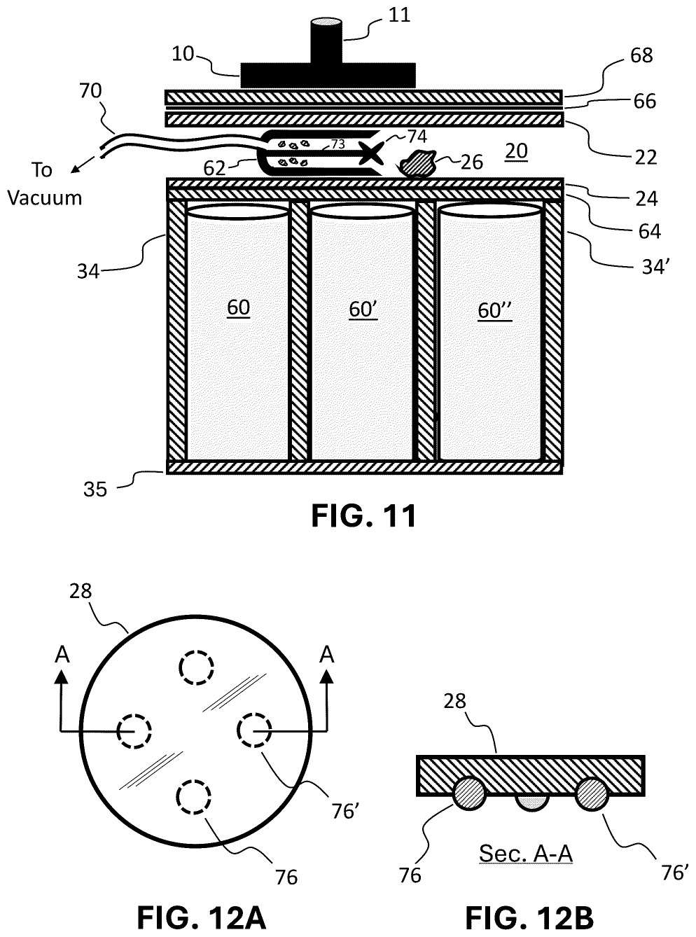

FIG. 11 shows a schematic elevation cross-section view of an example of three battery cells 60, 60′, 60″ and a vent gas manifold channel 20 with an obstruction 26 inside of channel 20, according to the present disclosure. This figure is identical to FIG. 9, with the exception being the addition of a horizontal shaft 73 (attached to steel bucket 62) with a one or two rotating sharp blades 74 rotatably attached to the distal end of horizontal shaft 73. Sharp rotatable blades 74 cut obstruction 26 into multiple, smaller pieces/fragments, which are easier to vacuum out through flexible vacuum tube 70. The rotating blades 74 may be driven by a battery-powered motor (not shown) or vacuum-driven.

FIG. 12A shows a schematic plan view of an example of a magnetically-coupled disc 28 with four spherical rollers 76, 76′, etc. disposed underneath disc 28, according to the present disclosure.

FIG. 12B shows an elevation cross-section view of an example of a magnetically-coupled disc 28 with four spherical rollers 76, 76′, etc. disposed underneath disc 28, according to the present disclosure. In some embodiments, cylindrical rollers may be used. The number of rollers may be three, four, five, or six, selected to provide omni-directional motion with reduced friction of sliding along channel 20.

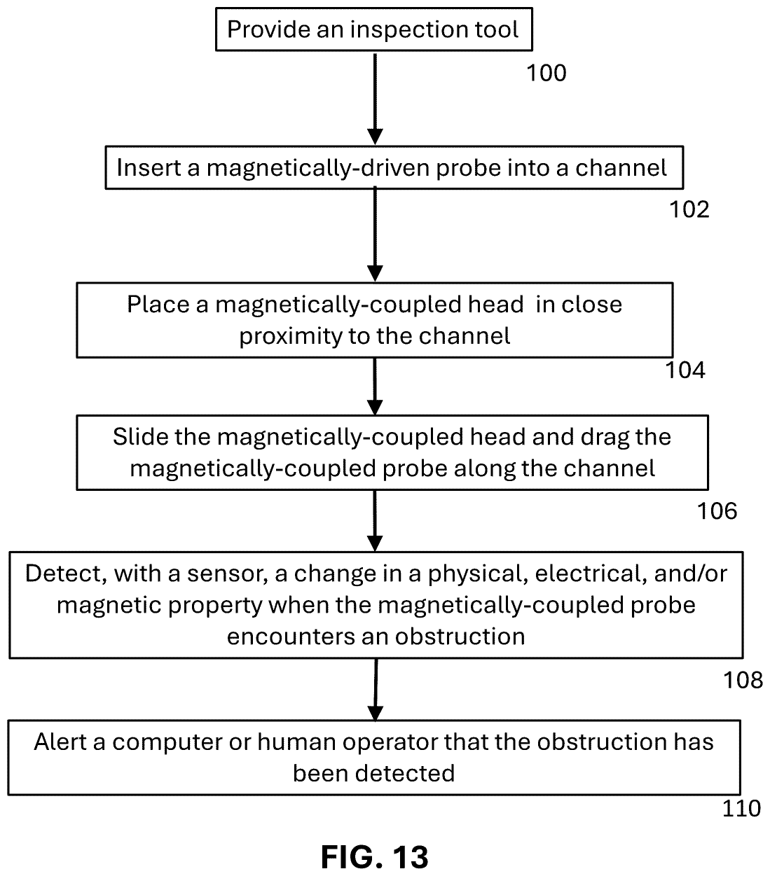

FIG. 13 shows an example of a process flow chart showing a method of inspecting a vent gas manifold channel. The example of a process flow chart comprises the following steps:
Step 100: Provide an inspection toolset;
Step 102: Insert a magnetically-coupled probe into a channel;
Step 104: Place a magnetically-coupled head in close proximity to the channel;
Step 106: Slide the magnetically-coupled head and drag the magnetically-coupled probe in the channel;
Step 108: Detect, with the sensor, a change in a physical, electrical, and/or a magnetic property when the magnetically-coupled probe encounters an obstruction; and
Step 110: Alerting a computer or a human operator that the obstruction has been detected.

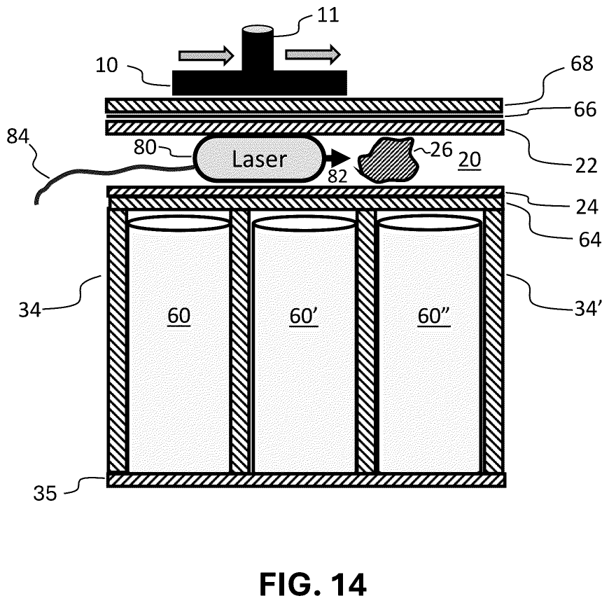

FIG. 14 shows a schematic elevation cross-section view of an example of three battery cells 60, 60′, 60″ and a vent gas manifold channel 20 with an obstruction 26 and a magnetically-coupled laser 80 disposed inside of the channel 20, according to the present disclosure. Magnetically-coupled laser 80 may be inserted into channel 20 after magnetically-coupled probe 28 (not shown) has located obstruction 26 and alerted an operator (not shown). Magnetically-coupled laser 80, with attached power cord 84, may be made with a steel casing, and may be moved into an appropriate position (i.e., dragged) by magnetically-coupled head 10. Alternatively, magnetically-coupled laser 80 may function as magnetically-coupled probe 28 and be dragged along channel 20 by magnetically-coupled head 10 until it encounters obstruction 26 and alerts a computer or an operator. Once positioned sufficiently close to obstruction 26, magnetically-coupled laser 80 may irradiate obstruction 26 with a laser beam 82 of sufficient power (and appropriate wavelength) to heat up and completely vaporize obstruction 26.

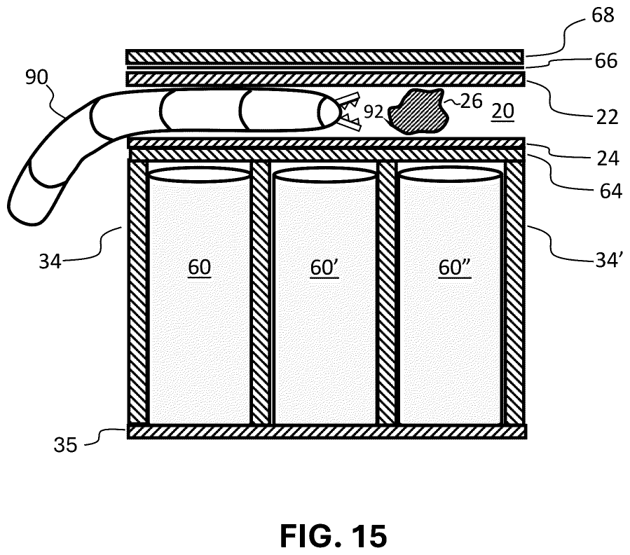

FIG. 15 shows a schematic elevation cross-section view of an example of three battery cells 60, 60′, 60″ and a vent gas manifold channel 20 with an obstruction 26 and a borescope 90 with a pair of snipper jaws 92, 92′ disposed inside of the channel 20, according to the present disclosure. Once the location of an obstruction 26 inside of channel 20 has been identified by inspection tool 15, magnetically-coupled probe 28 may be removed. Then, borescope 90 (with a pair of snipper jaws 92, 92′) may subsequently be inserted into channel 20, adjacent to the location of obstruction 26. Finally, snipper jaws 92, 92′ may snip and cut obstruction 26 into smaller pieces or fragments (not shown), which may be later vacuumed out with a vacuum hose (not shown).

In some embodiments, magnetically-coupled probe 28 may be configured to grind away obstruction 26 with one or more rotating rollers or gear elements (not shown), which may be driven by a battery-powered motor (not shown).

In some embodiments, a computerized algorithm may be used to control a robot manipular arm that guides the magnetically-coupled probe 28 through the interconnected series of parallel vent gas manifold channels 20, 20′, 20″, etc. inside of vent gas manifold 42.

In some embodiments, the vent gas manifold channels 20, 20′, 20″, etc. and the manifold 42 itself may be made of a non-magnetic material (e.g., aluminum, a polymer, or fiber-reinforced polymer composite material).

In some embodiments, magnetically-coupled probe 28 may be a bucket-shaped scoop 62 with upper and lower sharp leading edges 65 and 63, respectively, and that is made of steel or a magnetic material.

In some embodiments, vent gas manifold channel 20 may be a rectangular, tubular channel.

In some embodiments, vent gas manifold channel 20 may be an integral part of a battery pack in an electric vehicle, electric airplane, electric boat or submarine, or electric drone.

In some embodiments, obstruction 26 may comprise a blob of potting compound that has intruded into channel 20.

In some embodiments, the inspection tool 25 may further comprise a shaft 12 that is attached to the magnetically-coupled head 10.

In some embodiments, the method may further comprise measuring a lateral force, a torque, and/or a lateral deflection of shaft 12 that is generated when the magnetically-coupled probe 28 encounters obstruction 26 located inside of channel 20.

In some embodiments, the method may further comprise measuring with sensor 14 (a) a change in an electrical capacitance of a probe/magnet combination; and/or (b) a change in an electrical inductance of the magnetically-coupled head 10; when the obstruction 26 is encountered.

In some embodiments, the inspection tool may be attached to a robot manipulator arm 18; and the method may further comprise moving the inspection tool 15 and the magnetically-coupled probe 28 along the channel with the robot manipulator arm 18.

In some embodiments, the method may further comprise removing the obstruction 26 from the channel 20 after the magnetically-coupled probe 28 has located and detached and/or ground down the obstruction 26.

In some embodiments, the method may further comprise removing the magnetically-coupled probe 28 from the channel after inspection has been completed.

In some embodiments, the method may further comprise holding and/or trapping the magnetically-coupled probe 28 at one end of the channel 20 after inspection has been completed.

In some embodiments, removing the obstruction 26 may comprise (1) magnetically-driving the magnetically-coupled head 10 and a magnetically-coupled bucket 62 disposed inside of the channel, wherein the magnetically-coupled bucket 62 comprises lower and upper sharp leading edges 63, 65, respectively; (2) cutting away and detaching obstruction 26 from a wall of the channel 20 by pushing the magnetically-coupled bucket 62 forward into and past the obstruction, thereby cutting and creating a detached obstruction 26′; (3) holding the detached obstruction 26′ in the magnetically-coupled bucket 62; and then (4) removing the magnetically-coupled bucket 62, with the detached obstruction held inside, from the channel 20.

In some embodiments, the method may further comprise, vacuuming-up detached obstruction 26′ with a vacuum tube 70 attached to a rear end of the magnetically-coupled bucket 62; thereby removing the detached obstruction 26′ from channel 20.

In some embodiments, the magnetically-coupled bucket 62 may comprise a plurality of fixed or rotating blades 74 that cut the obstruction into a plurality of small, individual pieces of fragments that are easier to remove (e.g., by vacuuming up).

In some embodiments, channel 20 may be disposed within a battery vent gas manifold system 42 of an electric vehicle.

In some embodiments, holding the magnetically-coupled probe 28 at an end of the channel 20 after completing inspection may comprise rotating a one-way turn-style post 48 with a pair of arms 50, 52 that captures and traps the magnetically-coupled probe 28 at the end of the channel 20.

In some embodiments, herein holding the magnetically-coupled probe 28 at an end of the channel 20 after completing inspection may comprise using a permanent magnet 54 disposed at the end of the channel 20 to capture and hold the magnetically-coupled probe 28 at the end of the channel 20.

In some embodiments, the inspection tool 15 may be attached to a robot manipulator arm 18; and the method may further comprise moving the inspection tool 15 and the magnetically-coupled probe 28 along a length of the channel with the robot manipulator arm 18.

In some embodiments, a paper or plastic “map” of the interconnected channels 20, 20′, 20″, etc. can be placed or adhesively-attached on the battery pack's exterior surface to indicate where the internal channels are located inside. This may aid a human operator when manually moving the inspection probe 15 along the twists and turns of the interconnected channels 20, 20′, 20″, etc. Alternatively, a video projector may project the “map” of the channels 20, 20′, 20″, etc. onto the battery pack's exterior surface.

In some embodiments, a magnetically-coupled laser 80, with a steel casing, may be inserted into channel 20, magnetically dragged to a location of the obstruction 26 by the magnetically-coupled head, 10 and then irradiate the obstruction 26, thereby heating it up and vaporizing it.

In another example laser 80 may function as the magnetically-coupled probe 28 and be magnetically-dragged along the channel 20 by the magnetically-coupled head 10 until it encounters the obstruction 26 and alerts an operator, prior to vaporizing the obstruction 26 with the laser.

In another example, a borescope with snipper jaws may be inserted into the channel and the snipper jaws may cut away the obstruction into small fragments that may be vacuumed out with a separate vacuum tool.

The detailed description and the drawings or figures are supportive and descriptive of the present teachings, but the scope of the present teachings is defined solely by the claims. While some of the best modes and other embodiments for carrying out the present teachings have been described in detail, various alternative designs and embodiments exist for practicing the present teachings defined in the appended claims.

What is claimed is:

1. An inspection toolset, comprising:
a magnetically-coupled probe sized to fit within, and slide along, a channel;
an inspection tool comprising a magnetically-coupled head disposed outside of the channel; and
a sensor, attached to, or disposed within, the magnetically-coupled head;
wherein the sensor is configured to detect when the magnetically-coupled probe has encountered an obstruction located inside of the channel; and
wherein the magnetically-coupled head and the magnetically-coupled probe are magnetically-coupled together to make a magnetically-coupled probe/head pair that have a magnetic strength sufficiently strong to drag the magnetically-coupled probe inside the channel when the magnetically-coupled head is moved outside of the channel.

2. The inspection toolset of claim 1, further comprising:
a shaft attached to the head and the sensor, disposed in-between the head and the sensor; and
wherein the sensor is configured to sense an increase in a lateral force, a torque, and/or a lateral deflection of the shaft when the magnetically-coupled probe encounters the obstruction located inside of the channel.

3. The inspection toolset of claim 1, wherein the sensor senses:
(a) a change in an electrical capacitance of the magnetically-coupled probe/head pair and/or
(b) a change in an electrical inductance of an electromagnet disposed inside of the magnetically-coupled head;
when the magnetically-coupled probe encounters the obstruction.

4. The inspection toolset of claim 1, wherein the inspection tool is attached to, and manipulated by a robotic manipulator arm; or manipulated by a human operator.

5. The inspection toolset of claim 1, wherein the channel is disposed within a battery vent gas manifold system of an electric vehicle.

6. A method of inspecting a channel with an inspection toolset, the method comprising:
(a) providing an inspection toolset comprising:
a magnetically-coupled probe sized to fit within, and slide along, the channel;
an inspection tool comprising a magnetically-coupled head disposed outside of the channel; and
a sensor, attached to, or disposed within, the magnetically-coupled head;
wherein the sensor is configured to detect when the magnetically-coupled probe has encountered an obstruction located inside of the channel; and
wherein the magnetically-coupled head and the magnetically-coupled probe are magnetically-coupled together to make a magnetically-coupled probe/head pair that have a magnetic strength sufficiently strong to drag the magnetically-coupled probe inside the channel when the magnetically-coupled head is moved outside of the channel;
(b) inserting the magnetically-coupled probe into the channel;
(c) placing the magnetically-coupled head in close proximity to the channel and sliding the magnetically-coupled head along the channel, thereby dragging the magnetically-coupled probe along the channel;
(d) detecting, with the sensor, one or more changes in a physical, electrical, and/or a magnetic property of the inspection tool when the magnetically-coupled probe encounters the obstruction; and
(e) alerting a computer or a human operator that the obstruction has been detected.

7. The method of claim 6, further comprising applying a physical map, or projecting a video display, to an exterior surface of a battery pack, showing locations of internal channels disposed within a battery pack, and using the map or display to guide a human operator to move the magnetically-coupled probe along the channel.

8. The method of claim 6,
wherein the inspection tool further comprises a shaft attached to the magnetically-coupled head; and
wherein the method further comprises measuring a lateral force, a torque, and/or a lateral deflection of the shaft that is generated when the magnetically-coupled probe encounters the obstruction located inside of the channel.

9. The method of claim 6, further comprising measuring with the sensor:
(a) a change in an electrical capacitance of the magnetically-coupled probe/head pair; and/or
(b) a change in an electrical inductance of an electromagnet disposed within the magnetically-coupled head;
when the obstruction is encountered.

10. The method of claim 6,
wherein the inspection tool is attached to a robot manipulator arm; and
wherein the method further comprises moving the inspection tool and the magnetically-coupled probe along the channel with the robot manipulator arm.

11. The method of claim 6, further comprising:
(f) removing the obstruction from the channel after the magnetically-coupled probe has located the obstruction; and
(g) removing the magnetically-coupled probe from the channel after inspection has been completed.

12. The method of claim 11,
wherein the magnetically-coupled probe comprises ferrous steel or a magnet; and
wherein the magnetically-coupled head comprises a ferrous steel or a magnet.

13. The method of claim 11, further comprising holding or trapping the magnetically-coupled probe at one end of the channel after inspection has been completed.

14. The method of claim 11, wherein removing the obstruction in step (f) comprises:
(1) magnetically moving, with a magnetically-coupled head, a magnetically-coupled bucket disposed inside of the channel, wherein the magnetically-coupled bucket comprises upper and lower sharp leading edges;
(2) cutting away and detaching the obstruction from a wall of the channel by pushing the magnetically-coupled bucket forward into and past the obstruction, thereby cutting off and creating a detached obstruction;
(3) holding the detached obstruction in the magnetically-coupled bucket; and then
(4) removing the magnetically-coupled bucket, with the detached obstruction held inside, from the channel.

15. The method of claim 14, further comprising, after step (2), vacuuming up the detached obstruction with a vacuum tube attached to a rear end of the magnetically-coupled bucket; thereby removing the detached obstruction from the channel.

16. The method of claim 14, further comprising using a plurality of fixed or rotating blades; or a pair of snipper jaws, or a plurality of rotating gears, that cut or grind the obstruction into a plurality of small, individual pieces.

17. The method of claim 14, wherein the channel is disposed within a battery vent gas manifold system of an electric vehicle.

18. The method of claim 13, wherein holding the magnetically-coupled probe at an end of the channel after completing inspection comprises rotating a one-way turn-style post with a pair of arms that captures and traps the magnetically-coupled probe at the end of the channel.

19. The method of claim 13, wherein the sensor comprises an ultrasound sensor or a Hall magnetic sensor.

20. A method of inspecting a channel with an inspection toolset, the method comprising:
(a) providing an inspection toolset comprising:
a magnetically-coupled probe sized to fit within, and slide along, the channel;
an inspection tool comprising a magnetically-coupled head disposed outside of the channel; and
a sensor, attached to, or disposed within, the magnetically-coupled head;
wherein the sensor is configured to detect when the magnetically-coupled probe has encountered an obstruction located inside of the channel; and
wherein the magnetically-coupled head and the magnetically-coupled probe are magnetically-coupled together to make a magnetically-coupled probe/head pair that have a magnetic strength sufficiently strong to drag the magnetically-coupled probe inside the channel when the magnetically-coupled head is moved outside of the channel;
(b) inserting the magnetically-coupled probe into the channel;
(c) placing the magnetically-coupled head in close proximity to the channel, and sliding the magnetically-coupled head along the channel, thereby dragging the magnetically-coupled probe along the channel;
(d) detecting, with the sensor, one or more changes in a physical, electrical, and/or a magnetic property of the inspection tool when the magnetically-coupled probe encounters the obstruction; and
(e) alerting a computer or a human operator that the obstruction has been located;
wherein the inspection tool further comprises a shaft attached to the magnetically-coupled head;
wherein the method further comprises measuring a lateral force, a torque, and/or a lateral deflection of the shaft that is generated when the magnetically-coupled probe encounters the obstruction;
wherein the inspection tool is attached to a robot manipulator arm; and
wherein the method further comprises moving the inspection tool and the magnetically-coupled probe along a length of the channel with the robot manipulator arm.
